(19) United States
(12) Patent Application Publication
(10) Pub. No.: US 2014/0146462 A1
(43) Pub. Date: May 29, 2014

(54) High Density Storage Applicance

(71) Applicant: Giovanni Coglitore, Saratoga, CA (US)

(72) Inventor: Giovanni Coglitore, Saratoga, CA (US)

(21) Appl. No.: 13/685,146

(22) Filed: Nov. 26, 2012

(51) Int. Cl. G06F 1/18

(52) U.S. Cl. CPC G06F 1/189
USPC 361/679.33

(57) ABSTRACT

A high-density storage appliance comprises a printed circuit board (PCB) to which a plurality of solid state drives (SSDs) are coupled. Each of the SSDs has a connector positioned along a width of the SSD, which is shorter than a height of the SSD. Further, each SSD is coupled to the PCB such that an aspect ratio of a height of the SSD above the PCB to a width of the SSD in parallel to the PCB is greater than 1.0. The SSDs may be arranged in a plurality of rows and a plurality of columns to simplify installation and removal of the SSDs and to facilitate airflow about the SSDs for cooling.

### BACKGROUND

This invention generally relates to data centers and more particularly to data storage appliances in data centers.

Based on advances in communications technologies improving high-speed and high-bandwidth communication between remote locations, data centers have become a practical solution for implementing large-scale distributed computing systems. A data center typically houses racks of computer servers providing both processing and data storage functionalities, as well as telecommunication and networking equipment, such as switches and routers, for transmitting data from and receiving data for the servers.

Conventional data centers rely on arrays of hard disk drives for data storage. However, solid state drives (SSDs) are becoming increasingly popular for options for data storage because of their lower access times and lower latency than conventional magnetic hard disk drives. Additionally, SSDs do not have moving parts, making them less susceptible to physical disruption and making them significantly quieter during operation. SSDs often share the same form factors and interfaces used by magnetic hard disk drives used in personal computers. However, conventional SSD interfaces and form factors are not suitable for use in high density storage appliances used in data centers.

### SUMMARY

Embodiments of the present invention provide a high-density storage appliance comprising a printed circuit board (PCB) to which a plurality of solid state drives (SSDs) are coupled. Each of the SSDs has a connector positioned along a width of the SSD, which is shorter than a height of the SSD. Further, each SSD is coupled to the PCB such that an aspect ratio of a height of the SSD above the PCB to a width of the SSD in parallel to the PCB is greater than 1.0. The height of the SSDs may be increased without altering the width of the SSDs to increase the amount of storage available in the high-density storage appliance without increasing the area of the PCB. The SSDs may be arranged in a plurality of rows and a plurality of columns to simplify installation and removal of the SSDs and to facilitate airflow about the SSDs for cooling. Other types of memory modules may be used in other implementations.

### BRIEF DESCRIPTION OF THE DRAWINGS

FIG. 1 is a diagram of a gumstick layout of a memory module, in accordance with one embodiment.

FIG. 2A is a top view of a high-density storage appliance, in accordance with one embodiment.

FIG. 2B is a perspective view of a layout of a storage bank 202 of a high-density storage appliance, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DESCRIPTION

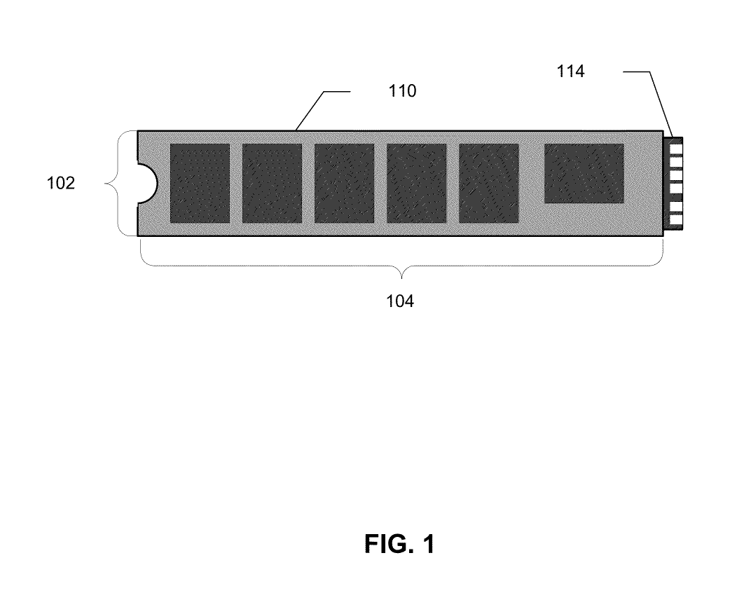

FIG. 1 is a block diagram illustrating a gumstick layout of a memory module 110 in accordance with one embodiment. The memory module 110 has a height 104 that is larger than its width 102. A connector 114 is located along the width 102 of the memory module 110 on a side of the memory module 110. The connector 114 may be multiple electrical contacts or “pins” for coupling to a connector of a printed circuit board (PCB). In contrast, conventional memory modules have a connector positioned along the length of the memory module. While positioning the connector 114 along the width 102 of the memory module 110 reduces the number of pins that may be used for the connector 114, this positioning of the connector 114 allows a greater number of memory modules 110 to be coupled to a particular area of a PCB.

In one embodiment, the memory module 110 is a solid state drive (SSD) having the gumstick layout described above. Multiple solid state drives are coupled to a PCB to create a high-density storage appliance. The gumstick layout increases the number of SSDs that may be coupled to a PCB of a particular area, increasing the amount of storage able to be provided by the high-density storage appliance.

In one embodiment the high-density storage appliance is enclosed in a housing adapted to be mounted in a standard 19 or 23-inch chassis. Inside the chassis, the high-density storage appliance is a PCB to which a plurality of solid state drives (SSDs) are coupled. Each of the SSDs has a connector 114 positioned along the width 102 of the SSD. Hence, each SSD is coupled to the PCB such that an aspect ratio of a height of the SSD above the PCB to a width of the SSD in parallel to the PCB is greater than 1.0. The height of the SSDs may be increased without altering the width of the SSDs to increase the amount of storage available in the high-density storage appliance without increasing the area of the PCB. For example, each SSD may be coupled to the PCB so the aspect ratio of the height of the SSD above the PDB to the width of the SSD in parallel with the PCB is greater than 1.5, 2.0, 2.5, or any other suitable value to increase the storage capacity of the high-density storage appliance. The height of the chassis may be 2 U or greater, where “U” is 1.75 inches.

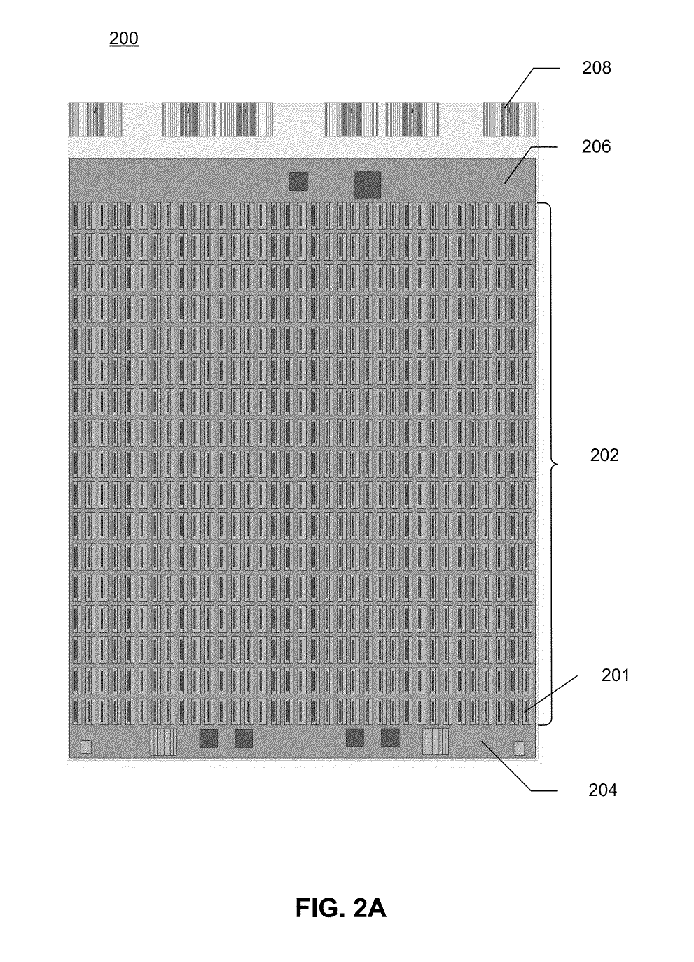

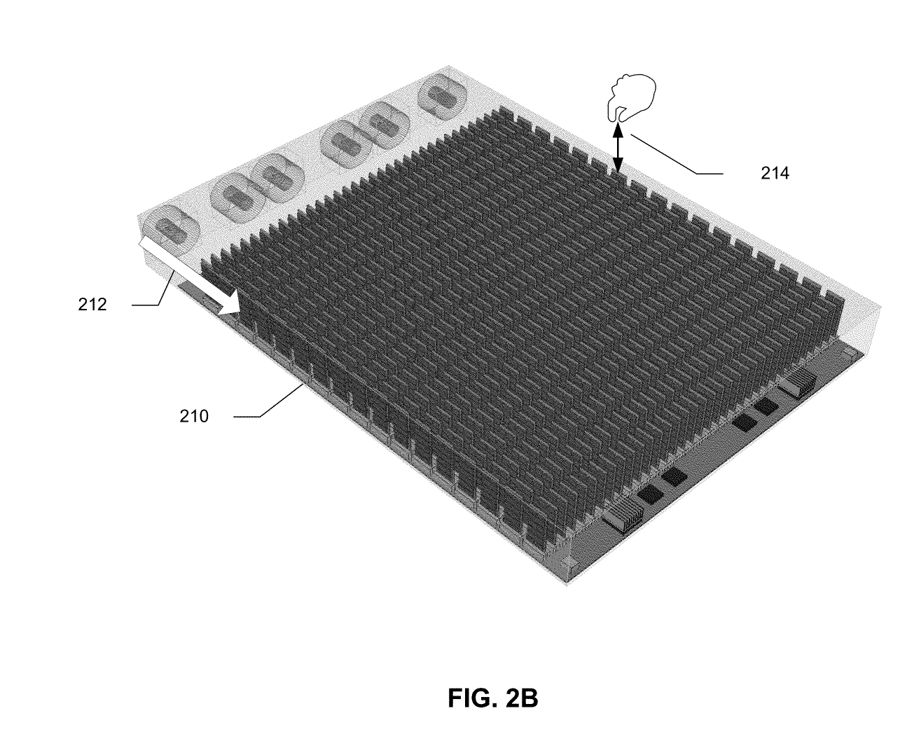

FIG. 2A is a top view of one embodiment of a high-density storage appliance 200. In the embodiment shown by FIG. 2A, the high-density storage appliance 200 comprises a storage bank 202, a controller circuit 204, a power circuit 206, and fans 208. The storage bank 202 includes a plurality of SSDs coupled to a PCB in a plurality of rows and a plurality of columns, creating a grid of SSDs. In the example of FIG. 2A, the storage bank 202 includes 17 rows by 35 columns of sockets 201, each configured to be coupled to a connector of a SSD. If the maximum number of SSDs are coupled to the PCB, the high-density storage appliance 200 shown in FIG. 2A includes 595 SSDs, providing a storage capacity of over 152 terabytes if 265 gigabyte SSDs are used. Other embodiments may contain more or less connectors arranged in the same of different layout to provide different storage capacities.

The controller circuit 204 exchanges data between SSDs in the storage bank and an external data switch or data bus. In one embodiment, the controller circuit 204 includes one or more embedded network processors, interface controllers, such as SAS (serial attached SCSI) adapters, fiber channel interfaces, and gigabyte data switches. For example, SAS adapters may configure the SSDs in the storage bank 202 to operate as a redundant array of independent disks (RAID). The controller circuit 204 may be coupled to external server units through optical fibers for high-speed data exchange. Data communication between external server units and SSDs in the storage bank 202 is managed by the controller circuit 204.

The power circuit 206 provides power from a power supply to the storage bank 202, controller circuit 204, and fans 208. In one embodiment, the power circuit 206 provides power from an alternating current (AC) power supply and may include batteries as a backup power source. Hence, the power circuit 206 may convert AC power into direct current (DC) power at levels suitable for user by the SSDs, controller circuit 240, and fans 208. For example, the power circuit 206 provides DC power at standard 12V, 5V, and 3.5V levels for the SSDs in the storage bank 202 and controller circuit 204. The power circuit 206 may also include fail safe or protection circuits to protect the SSDs and/or the controller circuit 204 from power surges.

The fans 208 direct air over the SSDs in the storage bank 202 and the controller circuit 204 to cool them during operation. In one embodiment, the fans 208 are oriented perpendicular to the width of the SSDs to maximize airflow between and around the SSDs in the storage bank 202. For example, if the SSDs are arranged in a plurality of rows and columns, the fan directs airflow through the channels between the SSDs to better cool the SSDs during operation.

FIG. 2B is perspective view of one embodiment of the layout of the storage bank 202 of the high-density storage appliance 200. As shown in FIG. 2B, the storage bank 202 includes SSDs arranged in a plurality of rows and a plurality of columns and coupled to a PCB 210 as described above in conjunction with FIG. 1. FIG. 2B also shows the fans 208 positioned perpendicular to a width of the SSDs, allowing airflow from the fans 208 to pass around the SSDs with minimal blockage from the SSDs, as shown by the airflow direction 212 indicated by FIG. 2B.

Additionally, each SSD is coupled to the PCB 210 such that an aspect ratio of a height of the SSD above the PCB 210 to a width of the SSD in parallel to the PCB 210 is greater than 1.0 simplifies installation and removal of a SSD. As shown in FIG. 2B, a SSD may be removed by moving it in a direction 214 perpendicularly away from the PCB 210. Additionally, arranging the SSDs in a plurality of rows and a plurality of columns provides spacing between the SSDs to allow individual SSDs to be accessed. Further, the small size of the connector 114 coupling the SSD to the socket on the PCB 210 may allow an administrator to use a single hand to remove or install a SSD in the storage bank without interfering with other SSDs in the storage bank.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a printed circuit board (PCB) including a plurality of sockets;
a plurality of solid state drives (SSDs) coupled to the PCB and arranged in a grid pattern comprising a plurality of rows and a plurality of columns, each solid state drive (SSD) coupled to the PCB such that an aspect ratio of a height of the SSD above the PCB to a width of the SSD in parallel to the PCB is greater than 1.0; and
a power circuit coupled to each of the plurality of SSDs and configured to distribute power from a power source to each of the plurality of SSDs.

2. The system of claim 1, further comprising one or more fans in a plane perpendicular to the widths of the SSDs and configured to direct air flow across the SSDs.

3. The system of claim 1, further comprising a controller circuit coupled to each of the plurality of SSDs and configured to manage data communication between one or more of the plurality of SSDs and an external device.

4. The system of claim 1, wherein the aspect ratio of the height of the SSD above the PCB to the width of the SSD in parallel to the PCB is greater than 1.5.

5. The system of claim 1, wherein the aspect ratio of the height of the SSD above the PCB to the width of the SSD in parallel to the PCB is greater than 2.0.

5. The system of claim 1, wherein the aspect ratio of the height of the SSD above the PCB to the width of the SSD in parallel to the PCB is greater than 2.5.

6. A system comprising:
a rack;
a housing configured to be mounted within the rack;
a printed circuit board (PCB) within the housing, the PCB including a plurality of sockets arranged in a grid pattern comprising a plurality of rows and a plurality of columns;
a plurality of solid state drives (SSDs) coupled to the PCB, each solid state drive (SSD) coupled to a socket included on the PCB such that an aspect ratio of a height of the SSD above the PCB to a width of the SSD in parallel to the PCB is greater than 1.0; and
a power circuit coupled to each of the plurality of SSDs and configured to distribute power from a power source to each of the plurality of SSDs.

7. The system of claim 6, further comprising one or more fans in a plane perpendicular to the widths of the SSDs and configured to direct air flow across the SSDs.

8. The system of claim 6, further comprising a controller circuit coupled to each of the plurality of SSDs and configured to manage data communication between one or more of the plurality of SSDs and an external device.

9. The system of claim 6, wherein the aspect ratio of the height of the SSD above the PCB to the width of the SSD in parallel to the PCB is greater than 1.5.

10. The system of claim 6, wherein the aspect ratio of the height of the SSD above the PCB to the width of the SSD in parallel to the PCB is greater than 2.5.
